(19) United States
(12) Patent Application Publication
(10) Pub. No.: US 2003/0128686 A1
(43) Pub. Date: Jul. 10, 2003

(54) Variable delay buffer

(76) Inventor: Nam Chun Hur, Gunpo-shi (KR)

Correspondence Address: FLESHNER & KIM, LLP, P.O. BOX 221200, CHANTILLY, VA, 20153, US

(21) Appl. No.: 10/309,318

(22) Filed: Dec. 4, 2002

(30) Foreign Application Priority Data
Dec. 6, 2001 (KR) 2001-77121
Aug. 28, 2002 (KR) 2002-51215

(51) Int. Cl. H04J 3/00

(52) U.S. Cl. 370/345

(57) ABSTRACT

Embodiments of the present invention relate to a system including a first buffer and a second buffer. The first buffer and the second buffer may temporarily store communication data in a communication system, as it is being processed. The output of the first buffet may be coupled to an input of the second buffer. A delay of the first buffer may be variable according to the amount of data stored in the second buffer.

### BACKGROUND OF THE INVENTION

1. Field of the Invention

The present invention generally relates to communication of data.

2. Background of the Related Art

Mobile radio communication systems are used in everyday life. Garage door openers, remote controllers for home entertainment equipment, cordless telephones, hand-held walkie-talkies, pagers, and cellular telephones are all examples of mobile radio communication systems. For example, cellular radio systems provide high quality service that is often comparable to that of landline telephone systems.

Abrupt changes do occur in a communications system. For instance, the amount of information being handled by a communications system may be abruptly increased. Alternatively, the capacity of a communications system may be abruptly diminished. In these exemplary circumstances, if a communications system does not adapt quickly, data will be lost. For instance, if a user is talking on their cellular phone and the communication system suddenly becomes overloaded, the user may not be able to continue their telephone conversation because data is lost in the communication system. Accordingly, there has been a long-felt need for communications systems that can adapt to abrupt changes in communication capacity.

### SUMMARY OF THE INVENTION

Embodiments of the present invention relate to a system including a first buffer and a second buffer. The first buffer and the second buffer may temporarily store communication data in a communication system, as it is being processed. The output of the first buffer may be coupled to an input of the second buffer. A delay of the first buffer may be variable according to the amount of data stored in the second buffer.

A buffer may be a memory device used in a communications system that delays the flow of information. If data is input into a buffer, that data stays in the buffer for a predetermined amount of time and is then output by the buffer. Buffers are important in communications systems, as communications systems cannot process data instantaneously and data may need to wait to be processed.

For example, data may be sequentially transferred between a first buffer and a second buffer in a communications system. However, the second buffer has a finite capacity. Accordingly, if the second buffer becomes full, data transferred from the first buffer to the second buffer may be lost, because there is no where to store data in the second buffer. Accordingly, in embodiments of the present invention, the rate at which data is transferred from the first buffer to the second buffer is dependent on how much data is stored in the second buffer.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary block diagram illustrating a multi-channel time schedule system.

FIG. 2 is an exemplary diagram illustrating a structure of a time alignment scheduler.

FIG. 3 and FIG. 4 are exemplary flow charts illustrating multi-channel time schedule methods.

### DETAILED DESCRIPTION OF PREFERRED EMBODIMENTS

In general, for a support mode of an Iu User Plane (UP) protocol of a 3^{rd} Generation Partnership Project (3GPP) Technical Specification (TS), an interface between a Core Network (CN) and a Radio Network Controller (RNC) of an asynchronous International Mobile Telecommunications (IMT)-2000 system may be required. A protocol may be for satisfying Quality of Service (QoS) for voice and image data that may require real-time services.

3GPP TS defines a Radio Network Layer (RNL) UP protocol being used over an Iu interface. One objective of an Iu UP protocol is to remain independent of a Core Network (CN) domain (Circuit Switched or Packet Switched) and to have limited or no dependency with a Transport Network Layer (TNL). Meeting this objective may provide for flexibility to evolve services regardless of a CN domain and to migrate services across CN domains. An Iu UP protocol may be defined with modes of operation that can be activated on a Radio Access Bearer (RAB) basis rather than on a CN domain basis or (tele) service basis. An Iu UP mode of operation may determine if features shall be provided to meet given requirements (e.g., the RAB QoS).

An Iu UP protocol may be located in an UP of a RNL over an Iu interface (i.e. an Iu UP protocol layer). An Iu UP protocol may be used to convey user data associated with RABs. One Iu UP protocol instance may be associated to a single RAB. If several RABs are established towards one given User Equipment (UE), then RABs may make use of several Iu UP protocol instances. An Iu UP protocol instance may exist at an Iu access point as defined 3GPP TS 25.410: “3rd Generation Partnership Project (3GPP) Technical Specification Group (TSG) RAN; UTRAN Iu interface: general Aspects and Principles” (i.e., at CN and Universal Terrestrial Radio Access Network (UTRAN)).

Modes of operation of an Iu UP protocol may be defined as a transparent mode and a support mode for a predefined Service Data Unit (SDU) size. Determination of an Iu UP protocol instance mode of operation is a CN decision taken at a RAB establishment based on characteristics (i.e. RAB characteristics). It may be signaled in a RNL control plane at a RAB assignment and relocation for each RAB. It may be internally indicated to an Iu UP protocol layer at a user plane establishment. Choice of a mode may be bound to the nature of an associated TAB and may not be changed unless a RAB is changed.

A transparent mode may be intended for RABs that do not require any particular feature from an Iu UP protocol other than transfer of user data. In a transparent mode, an Iu UP protocol instance may not perform any Iu UP protocol information exchange with its peer over an Iu interface (i.e. no Iu frame is sent). An Iu UP protocol layer may be crossed through by Protocol Data Units (PDUs) exchanged between upper layers and a transport network layer.

A support mode may be intended for RABs that may not require particular features from an Iu UP protocol in addition to transfer of user data. When operating in a support mode, peer Iu UP protocol instances may exchange Iu UP frames. In a transparent mode, an Iu UP frame may not be generated. Some RABs requesting Iu UP protocol support, constrain an Iu UP protocol and possibly radio interface protocols in specific ways. For instance, certain RABs may have variable predefined rates. An Iu UP support mode may be prepared to support variations. Functions (i.e. transfer of user data, initialization, rate control, time alignment, handling of error event, frame quality classification, etc.) may be needed to support a support mode.

A method of transferring voice at 64 Kbps may be used for voice transfer. However, as voice compression technology improves, it may be possible to compress voice at rates of 32 Kbps, 16 Kbps, 12 Kbps, or lower. Furthermore, compression efficiency may increase due to a possibility of noise reduction or mute reduction. Accordingly, a bandwidth in a transmission line may be reduced. Consequently, voice compression technology may be advantageous in that more subscribers may be accommodated in a given bandwidth that one system can process.

However, a packet data method, which is usually used for transferring compressed voice, may deteriorate the effect of real-time services because the packet data method is not operated by a Constant Bit Rate (CBR) but by a Variable Bit Rate (VBR). Accordingly, an Iu UP protocol may cover processes for rate control, data buffer, and error for real-time data transfer in order to satisfy QoS. For example, an Iu UP protocol may process requests for increase or decrease of data rate for voice or image depending on an environment of a structure between RNC subscribers and radio stations (i.e. muteness or noise). It may be required to have a time alignment function to deal with requests for data buffer delay or advance in accordance with an instantaneous change of rate. Also, it may be necessary to process services supported by relevant time alignment functions almost in real-time for a relatively large numbers of subscribers. Providing real-time services through time alignment functions in a support mode necessitate a buffer delay or advance by certain time unit according to a given environment.

Embodiments of the present invention relate to a multi-channel time schedule system. At a time of transferring data (i.e. voice and/or image), embodiments respond to requests for a transfer rate change. A transfer rate change may be caused by a change of environment of a mobile station or other circumstances (i.e. mute and noise conditions). A process may be performed by a data receiving system transferring rate control frames to a data transferring system. For example, it may be difficult to process an ongoing high data rate with currently-assigned bandwidth which can only process a low data rate. In embodiments of the present invention, a data receiving system may request data buffering (i.e., data delay) by generating a time alignment control frame. A data receiving system may transfer a time alignment control frame to a data transferring system. A time alignment service may be performed so that a request for canceling a previous buffer request (i.e., advance request) may be transferred to a data transferring system.

Embodiments of the present invention relate to a multi-channel time schedule system. A multi-channel time schedule system may perform time alignment service and/or perform time analysis for a relevant channel. In embodiments, a multi-channel time schedule system may compare, store, and monitor buffer delay time and/or advance time as requested from a data receiving system. A multi-channel time schedule system may transfer data if it is determined, from a comparison of a requested time and a stored time-set, that the requested time has elapsed. In other words, if a delay time is greater than a requested delay time or advance time, the data of a relevant channel may be transferred to a data receiving system.

Embodiments may provide time scheduling which may process time alignment service for a multiplicity of subscribers (i.e. from several thousand to tens of thousands subscribers) almost in real-time. Embodiments may perform a delay or an advance at a rate between 500 μs to 40 ms in increments of 500 μs. An “advance” may be defined as a relative advance of data processing, applied when there has been a delay request.

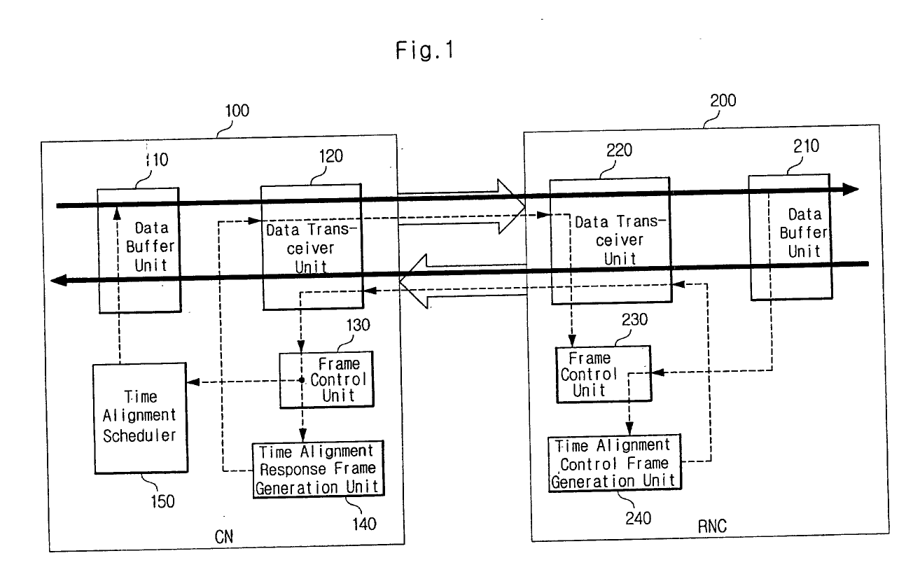

FIG. 1 illustrates a structure of exemplary embodiments of the present invention of a multi-channel time schedule system. A data transferring system CN (100) may comprise at least one of data buffer unit (110), data transceiver unit (120), frame control unit (130), time alignment response frame generation unit (140), and time alignment scheduler (150). Data receiving system RNC (200) may comprise at least one of data buffer unit (210), data transceiver unit (220), frame control unit (230), and time alignment control frame generation unit (240). CN (100) may transfer data to RNC (200). It should be well understood that embodiments of the present invention are not limited to the exemplary embodiments illustrated in FIG. 1 and may be applicable to other systems.

Data buffer unit (110) of CN (100) may transfer data stored in a data buffer to RNC (200) through data transceiver unit (120) of CN (100). This transfer may be according to a transfer control of time alignment scheduler (150) of CN (100). Data transceiver unit (120) of CN (100) may receive a time alignment control frame from RNC (200). Data transfer unit (120) may transfer a time alignment control frame to frame control unit (130) of CN (100). Data transceiver unit (120) may transfer a time alignment response frame received from time alignment response frame generation unit (140) of CN (100) to RNC (200). Data transceiver unit (120) may transfer data received from data buffer unit (110) of CN (100) to RNC (200).

Frame control unit (130) of CN (100) may check time schedule information by analyzing a time alignment control frame received from RNC (200) through data transceiver unit (120) of CN (100). Frame control unit (130) may issue an instruction for generation of a time alignment response frame for request of delay or advance (i.e. a response frame generation instruction) according to an analysis result. Frame control unit (130) may transfer an instruction to a time alignment response frame generation unit (140) and may simultaneously notify time alignment scheduler (150) of CN (100) of a checked time schedule information. A relevant time schedule information may be information required to request delay or advance for a certain amount of time for data (e.g., voice or image) which require real-time services. Time schedule information may comprise delay time or advance time requested from RNC (200) (i.e. a data receiving system). Time schedule information may comprise the time when storing was performed from a timer. Time schedule information may comprise a flag indicating valid or invalid status.

Time alignment response frame generation unit (140) of CN (100) may generate a time alignment response frame according to a response frame generation instruction received from frame control unit (130) of CN (100). Time alignment response time generation unit (140) may transfer a time alignment response frame to data transceiver unit (120) of CN (100).

Time alignment scheduler (150) of CN (100) may check receipt of a delay or advance request for a certain channel from RNC (200) by receiving time schedule information from frame control unit (130) of CN (100). Time alignment scheduler (150) may store a pointer indicating a relevant channel for which delay or advance is requested and may simultaneously store relevant time schedule information in a location of the pointer corresponding to a channel for which delay or advance is requested. Time alignment scheduler (150) of CN (100) may continuously check whether a relevant pointer is stored and may read the stored pointer. Time alignment scheduler (150) may read and analyze time schedule information stored in a memory area corresponding to a read pointer. If a requested time has elapsed, time alignment scheduler (150) may perform control to transfer data stored in data buffer unit (110) of the CN (100) to RNC (200).

Data buffer unit (210) of RNC (200) may store data in a data buffer, which has been received from CN (100) through data transceiver unit (220) of RNC (200) from CN (100). Data buffer unit (210) of RNC (200) may check whether a relevant data buffer is full or empty based upon a preset threshold of an amount of data stored in the relevant buffer. Data buffer unit (210) may transfer information of a checked data buffer state to frame control unit (230) of RNC (200).

Data transceiver unit (220) of RNC (200) may receive data and a time alignment response frame from CN (100). Data transceiver unit (220) may transfer received data to data buffer unit (210) of RNC (200). Data transceiver unit (220) may transfer a received time alignment response frame to frame control unit (230) of RNC (200). Data transceiver unit (220) may transfer a time alignment control frame received from time alignment control frame generation unit (240) of RNC (200) to CN (100).

Frame control unit (230) of RNC (200) may receive information of a data buffer state from data buffer unit (210) of RNC (200). Flame control unit (230) may issue an instruction for generation of a time alignment control frame for delay or advance (i.e. control frame generation instruction). Frame control unit (230) may transfer an instruction to time alignment control frame generation unit (240) of RNC (200) and may check whether there exists any time alignment response frame received from CN (100) through data transceiver unit (220) of RNC (200). If no time alignment response frame exists, frame control unit (230) of RNC (200) may recognize that an error has occurred and may issue a control frame generation instruction again by transferring a control frame generation instruction to time alignment control frame generation unit (240) of RNC (200).

Time alignment control frame generation unit (240) of RNC (200) may generate a time alignment control frame according to a control frame generation instruction received from frame control unit (230) of RNC (200). Time alignment control frame generation unit (240) may transfer a time alignment control frame to data transceiver unit (220) of RNC (200).

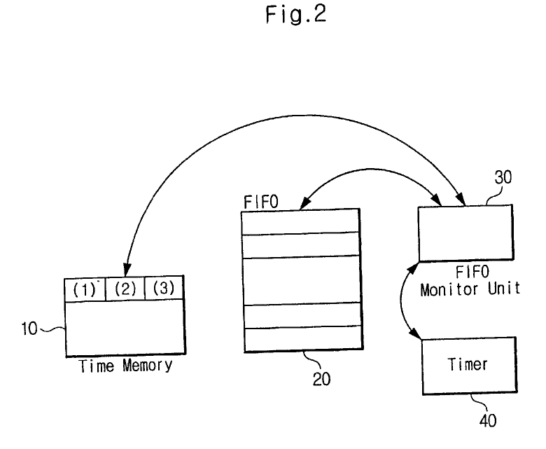

FIG. 2 is an exemplary illustration of time alignment scheduler (150). Time alignment scheduler (150) may comprise at least one of a time memory (10), a FIFO (20), a FIFO monitor unit (30), and a timer (40). Time memory (10) may receive time schedule information from frame control unit (130) of CN (100) and may store the time schedule information. FIFO (20) may, if time schedule information is to be newly registered in time memory (10), store a pointer indicating relevant channel location of time memory (10) (i.e. connection ID of a relevant channel). FIFO (20) may enable a first inputted pointer to be outputted first.

FIFO monitor unit (30) may monitor FIFO (20) and may, if there exists any stored pointer information, read pointer information. FIFO monitor unit (30) may compare time values by accessing an area of time memory (10) indicated by a relevant pointer. FIFO monitor unit (30) may comprises a time comparison unit comparing a time value stored in time memory (10) with the current time. FIFO monitor unit (30) may comprise a part monitoring a FIFO which stores a connection ID for a data transfer process (i.e. FIFO (20)).

A time value may be stored in a time memory. A current time may be compared to a time value stored in a memory. If a result of comparison of time stored in a time memory (10) and a current time counted by timer (40) is greater than or equal to a delay time requested from RNC (200) (i.e. a data receiving system), data stored in data buffer unit (110) may be transferred to RNC (200) (i.e. a data receiving system). Timer (40) may count time in real-time and may indicate such time in CN (100) (i.e. a data transferring system).

Embodiments of the present invention relate to a multi-channel time schedule method. If data transceiver unit (220) of a data receiving system (i.e. RNC (200)) receives data from a data transferring system (i.e. CN (100)) and transfers the data to data buffer unit (210) of RNC (200), then data buffer unit (210) may store data received from CN (100) in a data buffer. Data buffer unit (210) may check whether a relevant data buffer is full or empty based upon a pre-determined threshold of an amount of data. Data buffer unit (210) may transfer information regarding a checked data buffer state to frame control unit (230) of RNC (200).

Frame control unit (230) may receive information regarding a data buffer state from data buffer unit (210). Frame control unit (230) may issue an instruction for generation of a time alignment control frame concerning data delay or advance (i.e. control frame generation instruction). Frame control unit (230) may transfer an instruction to time alignment control frame generation unit (240) of RNC (200). Time alignment control frame generation unit (240) may generate a time alignment control frame according to a control frame generation instruction received from frame control unit (230). Time alignment control frame generation unit (240) may transfer a time alignment control frame through a data transceiver unit to CN (100).

Data transceiver unit (120) of CN (100) may receive a time alignment control frame from RNC (200). Data transceiver unit (120) may transfer a time alignment control frame to frame control unit (130) of CN (100). Frame control unit (130) may check time schedule information by analyzing a time alignment control frame received from RNC (200) through relevant data transceiver unit (120). Frame control unit (130) may issue an instruction for generation of a time alignment response frame for request of data delay or advance (i.e. a response frame generation instruction) according to an analysis result. Frame control unit (130) may transfer an instruction to time alignment response frame generation unit (140) of CN (100) and may simultaneously notify time alignment scheduler (150) of CN (100) of a checked time schedule information. Time alignment response frame generation unit (140) may generate a time alignment response frame corresponding to a response frame generation instruction received from frame control unit (130). Time alignment response frame generation unit (140) may transfer a time alignment response frame through data transceiver unit (120) to RNC (200).

Time alignment scheduler (150) may receive time schedule information from frame control unit (130). Time alignment scheduler (150) may store a pointer pointing a relevant channel which requires delay or advance and may simultaneously store relevant time schedule information in a location of the pointer corresponding to a channel which requires delay or advance. Time alignment scheduler (150) of CN (100) may continuously check whether a relevant pointer is stored, may read a stored pointer, may read and/or analyzes time schedule information stored in a memory area corresponding to a read pointer, and, if the requested time elapses, may perform control so that data stored in data buffer unit (110) of CN (100) may be transferred to RNC (200).

Embodiments of the present invention relate to a multi-channel time schedule method for transferring certain data requiring real-time services. The method may comprise at least one of the following steps. Checking time schedule information inputted from a data receiving system. Comparing and/or storing delay time and/or advance time requested from a data receiving system. Monitoring information regarding a relevant time. Comparing a requested time value and a time set value. If a requested time has elapsed, then transferring relevant data.

In embodiments, in the step of checking time schedule information, if a data receiving system (i.e. RNC (200)) requests a data transferring system (i.e. CN (100)) to delay or advance data for a certain time, the data transferring system may receive the request, read currently registered contents in time memory (10) of a relevant channel (i.e. flag and/or delay request time) and may update contents by comparing contents (i.e. information about delay and advance) with previous contents.

In embodiments, in the step of checking time schedule information, a data transferring system may check through a flag whether information regarding a delay has been previously registered. A data transferring system may store a pointer indicating a channel location of time memory (10) in a time memory pointer FIFO (i.e. FIFO (20)) if information is to be newly registered. If there is no need for a further delay, a data transferring system may delete a flag value of time memory (10).

In embodiments, in the step of monitoring information regarding a relevant time, if information about a delay is stored in time memory (10), FIFO monitor unit (30) may monitor FIFO (20) continuously. After reading a pointer value of FIFO (20) and checking a flag value of time memory (10) of a relevant channel, if the flag value has been cleared, the relevant pointer value may be deleted. If a relevant flag value has been set, a delay time may be compared with a difference between a current time counted by a timer and a time which has been stored in time memory (10).

If a difference between a current time and a time stored in memory (10) is greater than or equal to a relevant delay time, data stored in data buffer unit (110) may be transferred and time memory (10) may be reset with the current time. If a difference between a current time and time stored in memory is less than a relevant delay time, data may remain stored and steps may be performed to read the next pointer. A time memory pointer FIFO may be used for FIFO (20) in order to implement substantially real-time time scheduling for N channels. Only registered channels may be considered in this operation through applying deletion and registration of delay and advance requests in order to reduce time required for time scheduling.

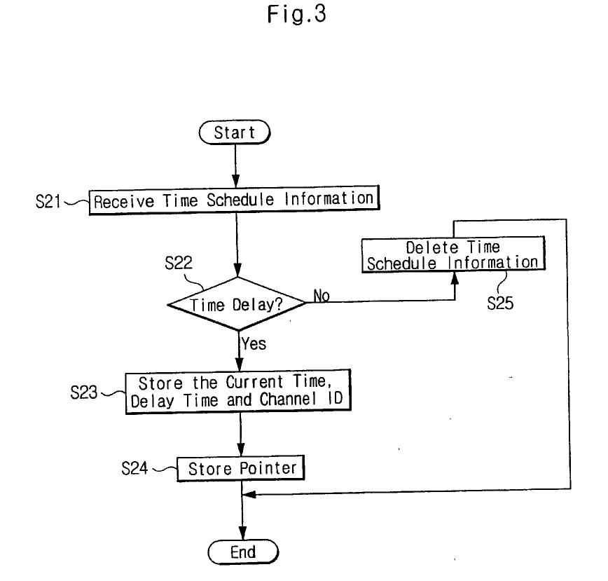

FIG. 3 illustrates an exemplary embodiment of the step of monitoring information regarding a relevant time. If RNC (200) (i.e. a data receiving system) inputs information for requesting delay or advance of data requiring real-time services (i.e., voice and image) to CN (100) (i.e. a data transferring system), CN (100) receives relevant time schedule information (S21). RNC (200) may input time schedule information comprising delay time or advance time requested from RNC (200), a time at the moment of storage from timer (40), flag indicating valid or invalid state, and/or channel ID.

CN (100) may determine whether time schedule information inputted from RNC (200) is information about a delay (S22). Information about delay may be defined as “500 μs N (1˜80: Delay)” in increments of 500 (μs). If time schedule information input from RNC (200) at step S22 is information about a delay, information about the delay (i.e. time at a time of a request by RNC (200), a channel ID, and/or a delay time requested from RNC (200)) may be stored in time memory (10) and a flag may be set (S23). A current time and a delay time may be set at a connection address and/or a valid flag may be declared.

When information about a delay is stored in time memory (10), it may be checked through a flag whether the information has been registered before. If information about a delay is to be newly registered, a pointer indicating a channel location of time memory (10) may be stored in FIFO (20) (S24).

If time schedule information inputted from RNC (200) at step S22 is not information about a delay but information about an advance. A step of monitoring information regarding a relevant time may be finished after deleting time schedule information received from time memory (10) and/or after clearing a flag because information about an advance may only have meaning after information about a delay has been received (S25).

If CN (100) receives information about an advance from RNC (200), CN (100) may check whether a valid flag has been set in time memory (10). This may be accomplished by taking relevant-inputted information about an advance as advance value of an inner timer device. Information about an advance may be defined as “500 μm N(129˜208: Advance)” in increments of 500 (μm).

If a valid flag has been set, an advance time may be subtracted from a current delay time. If a delay time is less than an advance time, a valid flag may be disabled and/or a time value initialized to zero. If information about an advance is inputted when a delay time has been already stored in time memory (10), a difference between a currently-stored delay time and an advance time may be stored in time memory (10). If a first difference is greater than or equal to a second difference, control is conducted so that data stored in data buffer unit (110) of CN (100) may be transferred to RNC (200). A first time difference may be the difference between a time at the moment when an advance request was made from RNC (200) and a current time counted by timer (40). A second difference may be the difference between a currently-stored delay time and an advance time.

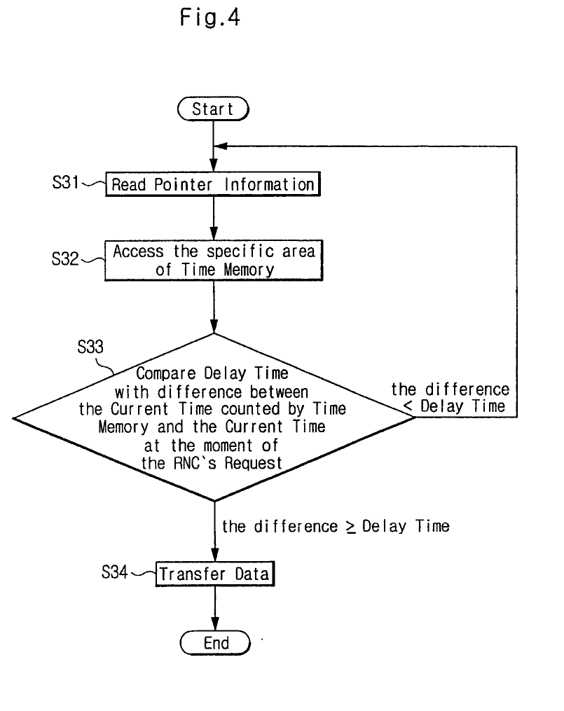

FIG. 4 is an exemplary illustration of a step of monitoring information regarding a relevant time. FIFO monitor unit (30) may monitor FIFO (20) to check whether data exists in FIFO (20). If existence of pointer information is recognized, FIFO monitor unit (30) may read the pointer information (S31). FIFO monitor unit (30) may access a specific area of time memory (10) which is indicated by a pointer read at step S31 (S32).

FIFO monitor unit (30) may compare a delay time requested by RNC (200) with a difference between a time at the moment of RNC (200)'s request and a current time counted by timer (40) (S33). If a difference between a time at the moment stored in time memory (10) and a current time is greater than or equal to a delay time requested from RNC (200), control may be conducted so that data stored in data buffer unit (110) of CN (100) may be transferred to RNC (200) (S34). Data buffer unit (110) may transfer data stored in a data buffer to RNC (200) via data transceiver unit (120) of CN (100) according to transfer control of time alignment scheduler (150).

If a difference between a time at the moment stored in time memory (10) and a current time is less than a delay time requested from RNC (200) at step S33, data stored in data buffer unit (110) may not be transferred and may remain stored unchanged. From step S31, the above-described steps may be iteratively performed until a difference between a time at the moment and a current time are greater than or equal to a delay time requested from RNC (200).

In other words, data may be read from FIFO (20) and relevant data may be used as a value of a pointer. An area of time memory (10) corresponding to a pointer may be read. Upon comparing a value read and a current internal time, if it is determined that a time expiration has occurred, a “done valid flag” of time memory (10) may be set and the current time reset.

If voice or image data requiring real-time services are inputted, it may be checked whether a “valid flag” of time memory (10) has been disabled. If it is determined that a “valid flag” has been disabled, relevant data may be transferred immediately. If it is determined that a “valid flag” has been enabled, it may be checked whether a “done valid flag” has been set. If a “done valid flag” has been set, relevant data may be transferred immediately. If a “done valid flag” has not been set, relevant data may remain unchanged in data buffer unit (110).

FIFO monitor unit (30) may detect whether data exists or not by reading an “enable” signal of FIFO (20). If it is detected that data exists, a “done valid flag” of time memory (10) may be checked through a pointer having an address corresponding to data as a pointer value. If a “done valid flag” has been set, data in data buffer unit (110) may be transferred immediately. If a “done valid flag” has not been set, an “enable” signal corresponding to a next connection ID of FIFO (20) may be monitored.

Embodiments of the present invention provide time alignment services, to provide a multi-channel time schedule system and a method implementing time scheduling in which real-time services for multi-channels are made possible so that the QoS for real-time voice or image data may be satisfied.

Embodiments of the present invention are for providing time alignment services, to implement time scheduling in which real-time services for multi-channels are made possible by buffering real-time voice or image data for certain time or transferring the data in advance by certain time difference.

Embodiments of the present invention are for providing time alignment services, to provide a timer apparatus monitoring information regarding time and a buffering apparatus for voice or image data so that information regarding buffer delay or advance may be received and that buffer delay or advance may be performed for certain time by using the received information.

Embodiments of the present invention are for providing time alignment services, to reduce time required for time scheduling by implementing real-time multi-channel time scheduling using a time memory pointer First In First Out (FIFO) and by considering only the actually registered channels through applying deletion or registration of delay and advance requests exactly as the deletion or registration is made.

Embodiments of the present invention relate to a multi-channel time schedule system that comprises: a data buffer unit of a data receiving system for storing data received from a data transferring system in a data buffer and checking whether the data buffer is full to the degree of the predetermined data amount or empty; a frame control unit of the data receiving system for receiving state information of the data buffer from the data buffer unit of the data receiving system and generating time alignment control frames for delay or advance information; a frame control unit of the data transferring system for checking time schedule information by analyzing the time alignment control frames received from the data receiving system; and a time alignment scheduler of the data transferring system for, upon receiving the time schedule information from the frame control unit of the data transferring system, storing a pointer indicating a channel for which the delay or advance is required and storing the time schedule information in the location of the pointer, and controlling the transfer of the data stored in the data buffer unit of the data transferring system according to the result of time analysis for the relevant channel conducted by comparing the time schedule information with the relevant information which has been stored previously.

In embodiments, a time schedule information may include delay time or advance time requested from the data receiving system; time indicating the moment of storage from the timer; flag indicating valid or invalid status; and channel identifier (ID). In embodiments, a time alignment scheduler may comprise: a time memory for receiving time schedule information from the frame control unit of the data transferring system and storing the time schedule information; a FIFO for, if the time schedule information is being newly registered in the time memory, storing a pointer which points the location of the channel of the time memory; a timer for counting the actual time and displaying such time in the data transferring system; and a FIFO monitor unit for monitoring the FIFO and, if there exists a stored pointer, comparing relevant time values by accessing the time memory area pointed by the pointer.

Embodiments of the present invention relate to a multi-channel time schedule system that comprises: a time memory for receiving time schedule information from a data receiving system in order to delay or advance data which require real-time services for certain time and storing the time schedule information; a FIFO for storing a pointer which indicates the location of the relevant channel for the time memory if the time schedule information is being newly registered in the time memory; a timer for real-time counting of time and displaying the time in the data transferring system; and a FIFO monitor unit for controlling the transfer of data stored in a data buffer of the data transferring system by monitoring the FIFO and, if there exists a pointer stored in the FIFO, comparing time values by accessing the time memory area pointed by the pointer.

In embodiments, if information regarding delay or advance is inputted from the data receiving system, the time memory stores delay time or advance time as requested by the data receiving system; the difference between the relevant delay time and advance time; channel ID; and the time as of the moment when the request was made from the data receiving system. In embodiments, the FIFO monitor unit comprises: a part which checks whether there is a connection ID stored in the relevant FIFO by monitoring the connection ID storage FIFO related to the data transfer process; and a time comparison unit which determines whether data stored in the data buffer of the data transferring system have been transferred by comparing the time value stored in the time memory and the current time.

In embodiments, the time comparison unit enables the data stored in the data buffer of the data transferring system to be transferred to the relevant data receiving system if the difference between the time stored in the time memory and the actual current time counted by the timer is greater than or equal to the delay time requested from the data receiving system. In embodiments, if it is determined, in the time comparison unit, that the difference between the time stored in the time memory and the actual current time counted by the timer is less than the delay time requested from data receiving system, the data that have been stored in the data buffer of the data transferring system remain as stored rather than being transferred, and the next connection ID is read.

Embodiments of the present invention relate to a multi-channel time schedule method for transferring data which require the real-time services, that comprises the steps of: comparing and storing delay time and advance time requested by a data receiving system by checking time schedule information inputted from the data receiving system; and transferring the data if it is determined that the requested time has elapsed upon comparing the requested time value and the time set value by monitoring the information regarding the relevant time.

In embodiments, the time schedule information includes delay time or advance time requested from the data receiving system; time of the moment when delay or advance was requested from the data receiving system; flag indicating valid or invalid state; and channel identifier (ID).

In embodiments, the step of comparing and storing comprises the steps of: receiving time schedule information from the data receiving system and determining whether the relevant time schedule information is information about delay; if the time schedule information is information about delay, storing the information about delay in the time memory and setting the flag; when storing the information about delay in the time memory, checking from the flag whether any information about delay has already been registered before; and, if it is determined that there has been no prior registration, storing a pointer indicating the relevant channel location of the time memory in a FIFO.

In embodiments, the step of comparing and storing further comprises the step of deleting the time schedule information and clearing the flag if the time schedule information is information about advance. In embodiments, the step of clearing further comprises the steps of: checking whether valid flag has been set in the time memory by setting the information about advance with the advance value of the timer device within the system; if the valid flag has been set, calculating the difference between the delay time stored in the time memory and the advance time; and, if the delay time is less than the advance time, disabling the valid flag value and initializing the time value as zero.

In embodiments, the step of transferring data comprises the steps of: if the time schedule information is being newly registered in the time memory, checking whether the flag of the time memory corresponding to the relevant channel has been set by monitoring the FIFO which stores a pointer indicating the relevant channel location of the relevant time memory and by reading the relevant pointer; if the flag of the time memory has been set, accessing the corresponding area of the time memory indicated by the pointer; comparing the delay time requested from the data receiving system with the difference between the time stored in the time memory and the current time counted by the timer; and, if the difference between these two times is greater than or equal to the delay time, transferring the data and resetting the current time in the time memory.

In embodiments, the step of transferring data further comprises, if the difference is less than the delay time, the step of storing the data as they are and checking whether the flag of the time memory corresponding to the relevant channel has been set, by reading the next pointer. In embodiments, the step of transferring data further comprises the step of deleting the pointer if the flag of the time memory has been cleared. In embodiments, the step of transferring data, if information about advance is inputted when the delay time has already been stored in the time memory, further comprises the steps of: calculating the second difference between the stored delay time and advance time; comparing the second difference with the first difference between the time at the moment when advance has been requested from the data receiving system and the current time counted by the timer; and, if the first difference is greater than or equal to the second difference, transferring the data and setting the current time at the time memory.

Embodiments of the present invention relate to a multi-channel time schedule method, for transferring data which require real-time services, comprises the steps of: updating a time memory by receiving time schedule information from a data receiving system and by comparing the time schedule information and information that has already been stored in the time memory; checking through the flag whether the time schedule information has been registered and, if the time schedule information is being newly registered, storing a pointer indicating the relevant channel location of the time memory in a FIFO; checking whether the flag of the time memory corresponding to the relevant channel has been set by reading the pointer through monitoring the FIFO and comparing delay time requested from the data receiving system with the difference between the current time counted by the timer and the time which has been stored in the time memory; and, if the difference is greater than or equal to the delay time, transferring the data and setting the current time in the time memory.

Embodiments of the present invention relate to a multi-channel time schedule method in a case where delay is no longer necessary for data which require real-time services, further comprises the steps of: deleting the flag of the time memory; and deleting the pointer if the flag of the time memory has been cleared.

Embodiments of the present invention relate to a multi-channel time schedule method, in a case where the difference is less than the delay time, further comprises the step of storing the data as they are and checking whether the flag of the time memory corresponding to the relevant channel has been set by reading the next pointer.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A system comprising:
first buffer; and
second buffer, wherein:
the output of the first buffer is coupled to an input of the second buffer; and
a delay of the first buffer is variable according to an amount of data stored in the second buffer.

2. The system of claim 1, wherein:
the first buffer is a multi-channel buffer; and
the second buffet is a multi-channel buffer.

3. The system of claim 2, wherein:
a delay of a first channel in the first buffer is variable according to an amount of data stored in a portion of the second buffer associated with the first channel.

4. The system of claim 2, comprising a memory associated with the first buffer, wherein the memory is configured to store delay information of a channel of the first buffer.

5. The system of claim 4, wherein the first buffet delays a channel of the first buffer according to delay information stored in the memory.

6. The system of claim 1, wherein:
the first buffer is comprised in a first device;
the second buffer is comprised in a second device; and
the first device and the second device are physically separated.

7. The system of claim 6, wherein the first device is a core network.

8. The system of claim 6, wherein the second device is a radio network controller.

9. The system of claim 6, wherein the second device is configured to periodically monitor an amount of data stored in the second buffer.

10. The system of claim 9, wherein the second device is configured to periodically determine if a delay of the first buffer should be varied according to a determined amount of data stored in the second buffer.

11. The system of claim 10, wherein the second device is configured to periodically determine if the delay of the first buffer should be increased, decreased, or unchanged according to a determined amount of data stored in the second buffer.

12. The system of claim 10, wherein the second device is configured to vary the delay of the first buffer through communication with the first device.

13. The system of claim 1, wherein the system is comprised in a communication system.

14. A method comprising:
transferring data from a first buffer to a second buffer; and
varying a delay of the first buffer according to an amount of data stored in the second buffer.

15. An apparatus comprising:
a first buffer;
a second buffer coupled to the first buffer; and
a means for varying a delay of the first buffer according to an amount of data stored in the second buffer.

16. A multi-channel time schedule system comprising:
a data buffer unit of a data receiving system for storing data received from a data transferring system in a data buffer and checking whether the data buffer is full to the degree of the predetermined data amount or empty;
a frame control unit of the data receiving system for receiving state information of the data buffer from the data buffer unit of the data receiving system and generating time alignment control frames for delay or advance information;
a frame control unit of the data transferring system for checking time schedule information by analyzing the time alignment control frames received from the data receiving system; and
a time alignment scheduler of the data transferring system for, upon receiving the time schedule information from the frame control unit of the data transferring system, storing a pointer indicating a channel for which the delay or advance is required and storing the time schedule information in the location of the pointer, and controlling the transfer of the data stored in the data buffer unit of the data transferring system according to the result of time analysis for the relevant channel conducted by comparing the time schedule information with the relevant information which has been stored previously.

17. A multi-channel time schedule system comprising:
a time memory for receiving time schedule information from a data receiving system in order to delay or advance data which require real-time services for certain time and storing the time schedule information;
a FIFO for storing a pointer which indicates the location of the relevant channel for the time memory if the time schedule information is being newly registered in the time memory;
a timer for real-time counting of time and displaying the time in the data transferring system; and
a FIFO monitor unit for controlling the transfer of data stored in a data buffer of the data transferring system by monitoring the FIFO and, if there exists a pointer stored in the FIFO, comparing time values by accessing the time memory area pointed by the pointer.

18. The system of claim 17, wherein the time memory stores, if information regarding delay or advance is inputted from the data receiving system, delay time or advance time as requested by the data receiving system; the difference between the relevant delay time and advance time; channel ID; and the time as of the moment when the request was made from the data receiving system.

19. The system of claim 17, wherein the FIFO monitor unit comprises:
a part which checks whether there is a connection ID stored in the relevant FIFO by monitoring the connection ID storage FIFO related to the data transfer process; and
a time comparison unit which determines whether data stored in the data buffer of the data transferring system have been transferred by comparing the time value stored in the time memory and the current time.

20. The system of claim 19, wherein the time comparison unit enables the data stored in the data buffer of the data transferring system to be transferred to the relevant data receiving system if the difference between the time stored in the time memory and the actual current time counted by the timer is greater than or equal to the delay time requested from the data receiving system.

21. The system of claim 19, wherein the data that have been stored in the data buffer of the data transferring system remain as stored rather than being transferred, and the next connection ID is read, if it is determined, in the time comparison unit, that the difference between the time stored in the time memory and the actual current time counted by the timer is less than the delay time requested from data receiving system.

22. A multi-channel time schedule method comprising:
comparing and storing delay time and advance time requested by a data receiving system by checking time schedule information inputted from the data receiving system; and
transferring the data if it is determined that the requested time has elapsed upon comparing the requested time value and the time set value by monitoring the information regarding the relevant time.

23. The method of claim 22, wherein the time schedule information includes delay time or advance time requested from the data receiving system; time of the moment when delay or advance was requested from the data receiving system; flag indicating valid or invalid state; and channel identifier (ID).

24. The method of claim 22, wherein the comparing and storing comprises:
receiving time schedule information from the data receiving system and determining whether the relevant time schedule information is information about delay;
if the time schedule information is information about delay, storing the information about delay in the time memory and setting the flag;
when storing the information about delay in the time memory, checking from the flag whether any information about delay has already been registered before; and
if it is determined that there has been no prior registration, storing a pointer indicating the relevant channel location of the time memory in a FIFO.

25. The method of claim 24, wherein the comparing and storing further comprises deleting the time schedule information and clearing the flag if the time schedule information is information about advance.

26. The method of claim 25, wherein the clearing further comprises:
checking whether valid flag has been set in the time memory by setting the information about advance with the advance value of the timer device within the system;
if the valid flag has been set, calculating the difference between the delay time stored in the time memory and the advance time; and
if the delay time is less than the advance time, disabling the valid flag value and initializing the time value as zero.

27. The method of claim 22, wherein the transferring data comprises:
if the time schedule information is being newly registered in the time memory, checking whether the flag of the time memory corresponding to the relevant channel has been set by monitoring the FIFO which stores a pointer indicating the relevant channel location of the relevant time memory and by reading the relevant pointer;
if the flag of the time memory has been set, accessing the corresponding area of the time memory indicated by the pointer;
comparing the delay time requested from the data receiving system with the difference between the time stored in the time memory and the current time counted by the timer; and
if the difference between these two times is greater than or equal to the delay time, transferring the data and resetting the current time in the time memory.

28. The method of claim 27, wherein the transferring data further comprises, if the difference is less than the delay time, storing the data as they are and checking whether the flag of the time memory corresponding to the relevant channel has been set, by reading the next pointer.

29. The method of claim 27, wherein the step of transferring data further comprises deleting the pointer if the flag of the time memory has been cleared.

30. The method of claim 27, wherein the transferring data, if information about advance is inputted when the delay time has already been stored in the time memory, further comprises:
calculating the second difference between the stored delay time and advance time;
comparing the second difference with the first difference between the time at the moment when advance has been requested from the data receiving system and the current time counted by the timer; and
if the first difference is greater than or equal to the second difference, transferring the data and setting the current time at the time memory.

31. A multi-channel time schedule method comprising:
updating a time memory by receiving time schedule information from a data receiving system and by comparing the time schedule information and information that has already been stored in the time memory;
checking through the flag whether the time schedule information has been registered and, if the time schedule information is being newly registered, storing a pointer indicating the relevant channel location of the time memory in a FIFO;
checking whether the flag of the time memory corresponding to the relevant channel has been set by reading the pointer through monitoring the FIFO and comparing delay time requested from the data receiving system with the difference between the current time counted by the timer and the time which has been stored in the time memory; and
if the difference is greater than or equal to the delay time, transferring the data and setting the current time in the time memory.
